(19) United States
(12) Patent Application Publication
(10) Pub. No.: US 2015/0158134 A1
(43) Pub. Date: Jun. 11, 2015

(54) METHOD FOR PRODUCING A TURBINE ROTOR OF AN EXHAUST GAS TURBOCHARGER

(71) Applicant: Audi AG, Ingolstadt (DE)

(72) Inventors: Oliver Henker, Quitzdorf am See (DE); Anton Stich, Ingolstadt (DE)

(73) Assignee: Audi AG, Ingolstadt (DE)

(21) Appl. No.: 14/407,016

(22) PCT Filed: Feb. 5, 2013
(86) PCT No.: PCT/EP2013/000338

§ 371 Date: Dec. 10, 2014

(30) Foreign Application Priority Data
Feb. 6, 2012 (DE) 10 2012 002 283.2

(51) Int. Cl. B23P 19/04

(52) U.S. Cl. CPC B23P 19/04; F05D 2230/60

(57) ABSTRACT

A method for producing a turbine rotor of an exhaust gas turbocharger, wherein the turbine rotor includes a turbine wheel with a hub and turbine blades that extend from the hub, and a shaft, includes the steps of: providing the turbine wheel, composed of a first material, and a shaft composed of a second material that is different from the first material; connecting the shaft to the hub of the turbine wheel; and forming a protective layer by applying or introducing a halogen on or in the surface of the turbine wheel and subsequently heat-treating the turbine rotor, the heat treatment being carried out in an environment having an oxygen partial pressure which is greater than a first oxygen partial pressure from which the first material is oxidized and is less than a second oxygen partial pressure from which the second material is oxidized.

The invention relates to a method for producing a turbine rotor of an exhaust gas turbocharger, wherein the turbine rotor is composed of a turbine wheel with a hub and turbine blades extending from the hub, as well as a shaft.

The response behavior or the torque build-up of an internal combustion engine charged by an exhaust gas turbocharger depends primarily on the mass moment of inertia of the rotor assembly of the exhaust gas turbocharger, in particular on the turbine rotor thereof. The major part of the mass moment of inertia is generated by the mass of the turbine wheel, which is part of the turbine rotor. The smaller the mass, the quicker the torque build-up can take place. Accordingly, the response behavior of the internal combustion engine can be improved by reducing the mass of the turbine wheel. One approach to reduce the mass of the turbine wheel is the replacement of the typically employed nickel-based alloy, which has a density of about 8 g/cm³, with another material of lower density. The material used for the turbine wheel has ideally comparable high temperature properties, especially at temperatures exceeding 800° C., like those of nickel-based alloys. However, materials which have the mentioned properties, i.e. in particular have a low density and good high temperature properties, are typically not resistant to oxidation at the temperatures of more than 800° C. that are present in the exhaust gas turbocharger due to the flow of hot exhaust gas from the internal combustion engine. This means that these materials are subjected to an oxidation process during the operation of the exhaust gas turbocharger, which adversely affects the surface of the turbine wheel. This applies in particular to the turbine blades, which are directly exposed to the hot exhaust gas, but in principle also to the hub on which the turbine blades are arranged.

Object of the invention is therefore to provide a method for producing a turbine rotor of an exhaust gas turbocharger, which method on one hand can be executed in a cost-efficient manner, and on the other hand enables the production of a turbine rotor which is resistant to oxidation even at the high temperatures as encountered in the exhaust gas turbocharger. The turbine rotor, for example, should be made of a material that has a lower density compared to conventional nickel-based alloys.

This is attained according to the invention by the method having the features of claim 1. The method includes the steps of: providing the turbine wheel made of a first material and the shaft made of a second material that differs from the first material; connecting the shaft with the hub of the turbine wheel; and forming a protective coating through applying or incorporating a halogen on or in the surface of the turbine wheel, preferably the entire surface, as well as subsequently heat treating the turbine rotor, wherein the heat treating is carried out in an environment of oxygen partial pressure which is greater than a first oxygen partial pressure at which the first material oxidizes and which is smaller than a second oxygen partial pressure at which the second material oxidizes. The turbine rotor is an assembled turbine rotor. This means that the rotor is assembled from the turbine wheel and the shaft, which are formed or produced separately from each other. Upon production of the turbine rotor, the turbine wheel is connected with the shaft to thereby provide subsequently a unitary structure in the form of the turbine rotor. For this purpose, the turbine wheel and the shaft are first provided. This provision may also include manufacture thereof, with the turbine wheel being manufactured in particular by casting. Thus, the turbine wheel is hereby made of the first material and the shaft is made of the second material that is different from the first material.

After being provided, the turbine wheel and the shaft are connected with each other. The shaft in particular is joined with the hub of the turbine wheel. Subsequently, the protective coating is applied. This is realized by applying or incorporating the halogen, with the surface, in particular the entire surface, of the turbine wheel being treated with the halogen. The halogen may be applied in any suitable manner. For example, an ion implantation process, a dip-coating process, a spray-coating process or a paint-coating process may be used. For example, a plasma immersion ion implantation process or a beam line ion implantation process or the like may be used as an ion implantation process for ion implantation. In particular fluorine, chlorine, bromine, iodine or a mixture of these elements can be used as a halogen. The halogen shall be applied or incorporated, as already noted above, on or into the (preferably entire) surface of the turbine wheel, preferably, however, not the surface of the shaft.

After the application or incorporation, the entire turbine rotor, i.e. also the shaft, is subjected to a heat treatment. This heat treatment, which may also be referred to as a thermal activation or pre-oxidation, is executed at least at 500° C. to 900° C. A thermally resistant protective coating is being formed during this heat treatment. This protects the turbine wheel against excessive oxidation during operation of the exhaust gas turbocharger. During the heat treatment, the shaft is also exposed to heat. It is thus contemplated that the oxygen partial pressure of the environment of the turbine rotor is adjusted such that it is greater than the first oxygen partial pressure and smaller than the second oxygen partial pressure. The first material oxidizes when an oxygen partial pressure is greater than or equal to the first oxygen partial pressure. This also applies to the second oxygen partial pressure and the second material. When thus selecting or adjusting the oxygen partial pressure such that it is greater than the first oxygen partial pressure but smaller than the second oxygen partial pressure, impermissible oxidation of the shaft does not occur. Rather, the protective coating is applied to only the turbine wheel.

According to a refinement of the invention, a titanium alloy, in particular a titanium aluminide, is used as the first material. In the known embodiment, the turbine wheel is made of a nickel-based alloy which has a density of about 8 g/cm³, As afore-stated, it is useful to reduce the mass of the turbine rotor, in particular the turbine wheel, as much as possible so as to lower the mass moment of inertia. Especially suitable for this purpose is the titanium-aluminum alloy as a result of its significantly reduced density. Particularly preferred is the use of a titanium aluminide (TiAl) as the first material. The titanium-aluminum alloy has a density of about 4 g/cm³. By applying the halogen on the surface of the turbine wheel made of the titanium-aluminum alloy, a heat-resistant Al₂O₃ layer is formed during the subsequent heat treatment. This protects the titanium-aluminum alloy, in particular the titanium aluminide, against impermissible oxidation during the operation of the exhaust gas turbocharger.

According to a refinement of the invention, steel is used as the second material. The shaft is made from the second material which is different from the first material. For example, steel is used for obtaining good endurance strength of the turbine rotor. This steel is preferably hardened or quenched and tempered. The second material is selected such that the second oxygen partial pressure at which oxidation occurs is greater than the first oxygen partial pressure at which the first material oxidizes.

According to a refinement of the invention, heat treatment is executed at a temperature of at least 500° C. to at least 900° C. Preferably, the heat treatment is executed at a temperature that corresponds to the expected maximum temperature during the operation of the exhaust gas turbocharger, or exceeds it. This prevents further, although slight, oxidation immediately after the start-up of the exhaust gas turbocharger.

According to a refinement of the invention, at least part of the shaft is hardened before being connected to the hub. Even though the shaft may soften during the heat treatment when the temperature used is high enough, the shaft should be still hardened prior to its connection and thus prior to heat treatment. Hardening prior to connection has the advantage of being independent on the turbine wheel so that, for example, a connection site of the shaft to the hub of the turbine wheel can be hardened.

According to a refinement of the invention, at least a region of the shaft, in particular at least a bearing site of the shaft, may be hardened by further heat treatment. The shaft or the bearing site is usually hardened subsequent to the connection, but before finishing or balancing of the turbine rotor. In this case, hardening should be carried out after heat treatment. During heat treatment of the turbine rotor for formation of the protective coating, the shaft may soften, in particular, when the temperature during the heat treatment exceeds the homological temperature of the shaft material, i.e. the second material. Accordingly, the shaft has to be quenched and tempered again after the heat treatment. This is carried out by further heat treatment, usually followed by a rapid cooling of the shaft.

The invention will now be explained in more detail with reference to the exemplary embodiments illustrated in the drawings, without limiting the scope of the invention. It is shown in:

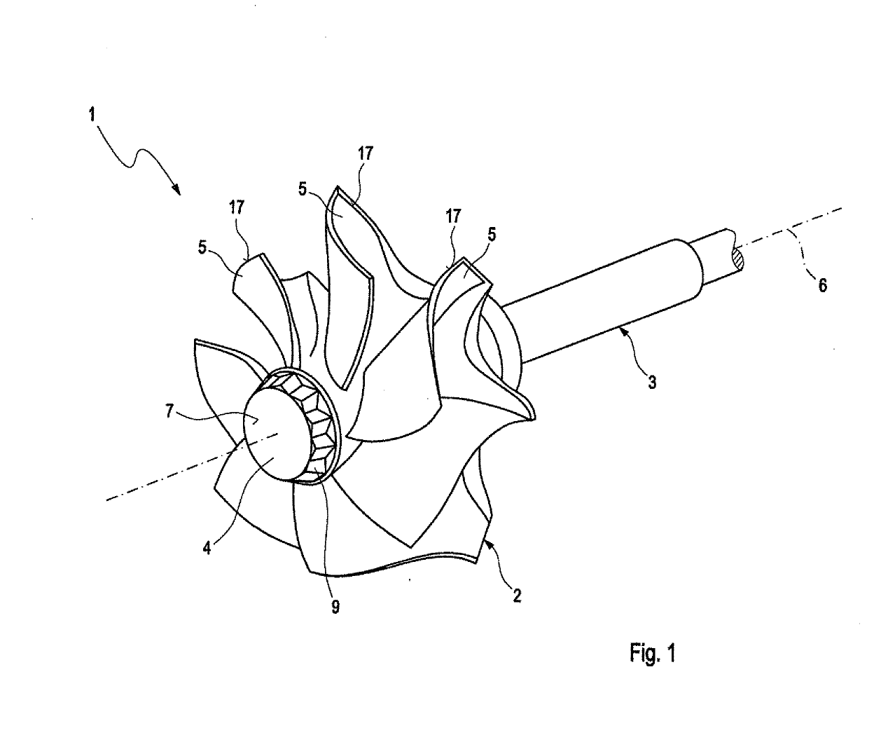

FIG. 1 a schematic illustration of a turbine rotor of an exhaust gas turbocharger having a turbine wheel with a hub and turbine blades extending from the hub, as well as a shaft,

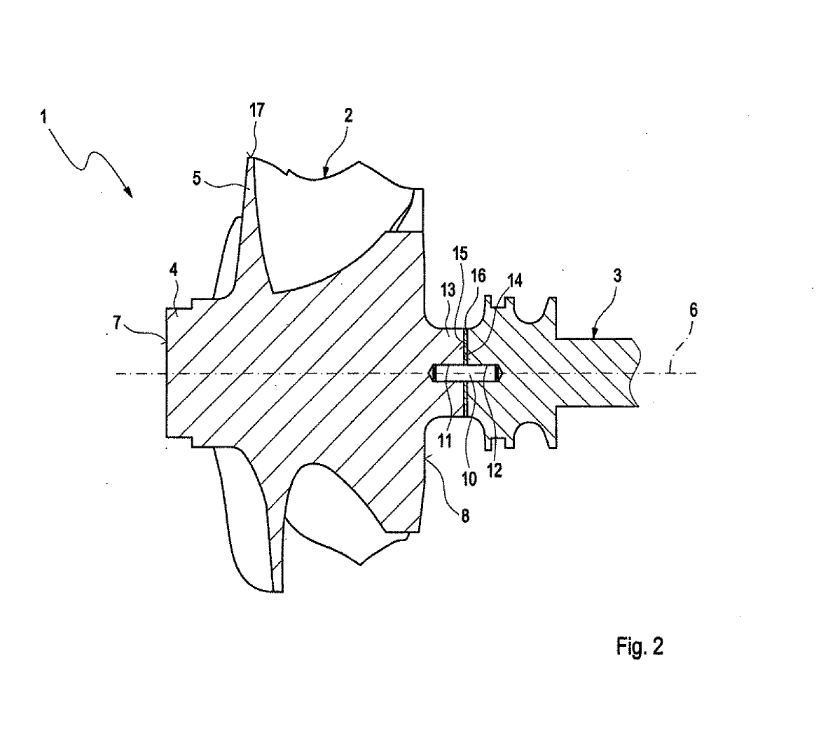

FIG. 2 a longitudinal section through the turbine rotor, and

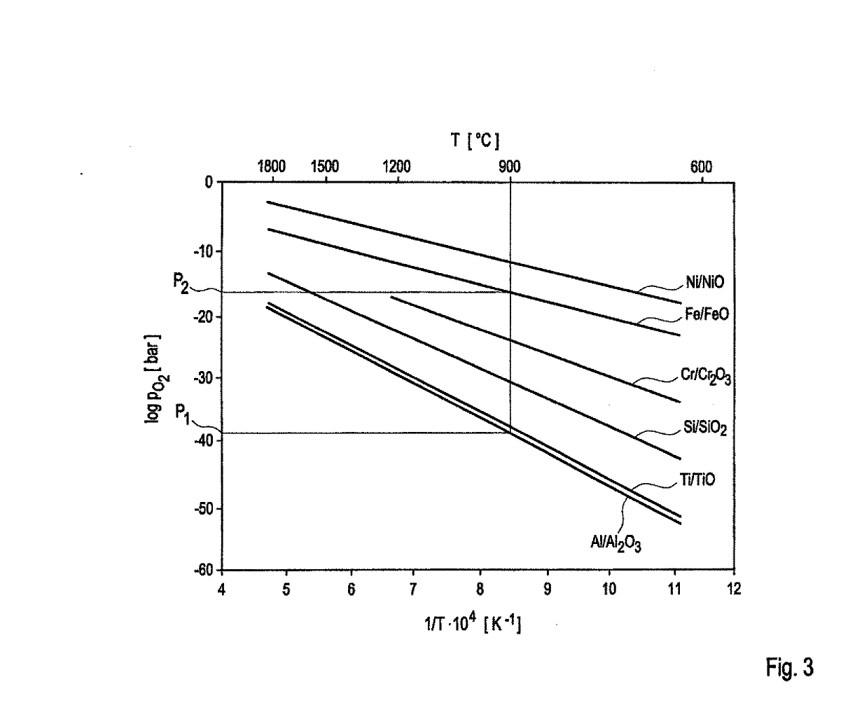

FIG. 3 a diagram in which oxygen partial pressure oxidations for different materials are plotted over the temperature.

FIG. 1 shows a turbine rotor 1 of an exhaust gas turbocharger, not shown in greater detail. The turbine rotor 1 includes a turbine wheel 2 and a shaft 3. The turbine rotor 1 is part of the exhaust gas turbocharger which is associated with an internal combustion engine. The turbine rotor 1 is normally rotatably mounted in a turbine housing, with a compressor wheel of a compressor being operatively connected with the turbine wheel 2 via the shaft 3. The turbine wheel 2 is composed of a hub 4 and a plurality of turbine blades 5, of which only some are labeled with reference numerals by way of example. The turbine blades 5 extend—in relation to a rotation axis 6 of the turbine rotor 1—from the hub 4 outwards in radial direction. The turbine wheel 2 is made, for example, from an aluminum alloy, in particular a titanium aluminide. Conversely, the shaft 3 is made of steel, for example, a low-alloy steel, in particular 34CrMo₄. The shaft 3 is firmly connected to the hub 4 of the turbine wheel 2. The hub 4 is formed as a polyhedron or polygon 9 in the region of a hub end face 7 which in the axial direction is located opposite to a wheel back 8, not visible here, of the turbine wheel 2. This polyhedron 9 is provided, in particular, to hold the turbine wheel 2 and the turbine rotor 1 during assembly of the exhaust gas turbocharger.

FIG. 2 shows a longitudinal section of the turbine rotor 1. The turbine wheel 2 and the shaft 3 are again discernable. It is readily apparent that the turbine wheel 2 and the shaft 3 are connected to each other by a fastener embodied as a centering pin 10, with the centering pin 10 engaging a recess 11 of the turbine wheel and a recess 12 of the shaft 3 in axial direction. The recess 11 is at least partially located in a fastening protrusion 13 of the turbine wheel 2, which extends in the axial direction (with respect to the rotation axis 6) from the wheel back 8 in the direction of the shaft 3. The fastening protrusion has an end face 14 in substantial parallel relation to an end face 15 located on a side of the shaft 3 facing the turbine wheel 2. The fastening protrusion 13 of the turbine wheel 2 and the shaft 3 have substantially identical or at least similar diameters in the region of the end faces 14 and 15. A solder film 16 may be provided between the end faces 14 and 15 to establish a lasting connection between the turbine wheel 2 and the shaft 3. Other types of fastening may, of course, also find application.

When the turbine rotor 1 is manufactured, the turbine wheel 2 and the shaft 3 are usually manufactured separately. In particular, the turbine wheel 2 is manufactured by casting. For example, during the manufacture of the turbine rotor 1 and after the turbine wheel 2 is cast, a joint of the turbine wheel 2, at which the connection to the shaft 3 is subsequently made, as well as the wheel back 8 are mechanically machined. Subsequently, the turbine wheel 2 is joined together with the shaft 3, which was previously quenched and tempered, to form the turbine rotor 1, with the shaft 3 being connected to the turbine wheel 2. Subsequently, at least one bearing site of the shaft 3, not shown here, can be hardened. However, this is optional. The turbine rotor 1 is then finished and balanced. Finishing and balancing involves a mechanical removal of material from the turbine rotor 1, for example by grinding or the like. In particular, the polyhedron 9 and a blade end face 17 of at least one of the turbine blades 5 are ground over. The blade end face 17 is formed at a free end of the turbine blade 5, which end is located on the side of the turbine blade 5 facing away from hub 4.

Because the turbine rotor 1 is subjected to a high temperature during operation of the exhaust gas turbocharger, i.e. is subjected to a high temperature stress, the turbine wheel 2 should be provided with a protective coating which is not shown in greater detail here. This is especially provided when the turbine wheel 2 is made of the titanium-aluminum alloy, for example titanium aluminide. In this case, it is particularly important to protect the turbine wheel 2 from unwanted oxidation caused by the high temperature stress. The coating is produced by first applying or incorporating a halogen on or in the surface of the turbine wheel 2. This is realized for at least a portion of the surface, preferably, however, for the entire surface. Subsequently, the turbine rotor 1 is heat-treated to form the protective coating.

When executing this heat treatment, after the shaft 3 has been connected to the turbine wheel 2, the shaft 3 is subjected to a temperature stress that may cause in some instances an undesired oxidation of the shaft 3. For this reason, the production of the turbine rotor 1 should proceed as follows: First, the turbine wheel 2 and the shaft 3 are provided, wherein the two components are formed or manufactured separately. The turbine wheel 2 is made hereby from a first material, the shaft from a second material which differs from the first material. Thereafter, the halogen is introduced onto or into the surface of the turbine wheel 2, and subsequently the entire turbine rotor 1 is heat-treated. During the heat treatment of the turbine rotor, the protective coating forms through oxidation on the turbine wheel 2. In order to simultaneously prevent undesirable oxidation of the shaft 3, the heat treatment is carried out in an environment which has a defined oxygen partial pressure that is greater than a first oxygen partial pressure and smaller than a second oxygen partial pressure.

The first oxygen partial pressure corresponds to the one oxygen partial pressure which, when reached or exceeded, causes oxidation of the first material at the specified temperature. Conversely, the second oxygen partial pressure is the one oxygen partial pressure which, when reached or exceeded, causes oxidation of the second material at the specified temperature. Thus, in order to prevent oxidation of the shaft 3, the oxygen partial pressure in the environment shall be selected such that it is smaller than the second oxygen partial pressure. At the same time, it shall be greater than the first oxygen partial pressure in order to realize the coating of the turbine wheel 2. In the environment of turbine rotor 1, both a specified temperature and a specified oxygen partial pressure are thus adjusted, with the first oxygen partial pressure and the second oxygen partial pressure being dependent on the adjusted temperature.

After the heat treatment of the turbine rotor 1, at least one area of the shaft 3 or at least a bearing site of shaft 3—if so desired—is hardened. This is carried out through further heat treatment, followed preferably by a rapid cooling of at least the shaft 3. Subsequently, the turbine rotor 1 is finished or balanced. For this purpose, material is removed from the finished turbine rotor 1, in particular in the area of the hub end face 7 or the polyhedron 9. Material is usually also removed from the blade end face 17. Accordingly, the protective coating is removed again in these regions. Therefore, it is provided to again form the protective coating at the blade end face 17 by renewed heat treatment. This renewed heat treatment can be realized in particular by operating the exhaust gas turbocharger. The protective coating, in particular in the form of the Al₂O₃ protective coating, is hereby formed by the halogen still contained in the turbine wheel 2. Thus, it is especially preferred that the protective coating is removed from the blade end face 17 such that the machining depth is smaller than the penetration depth of the halogen in the material of the turbine wheel 2. The halogen may, in principle, be chosen randomly. Especially preferred is the use of fluorine, chlorine, bromine, iodine or a mixture of these elements. Applying or incorporating the halogen can be realized by an ion implantation process, a dip-coating process, a spray-coating process, a paint-coating process and the like.

FIG. 3 shows a diagram in which the dependence of the oxygen partial pressure oxidations are plotted over the temperature for different materials. Behind each of the materials, the outcome of the oxidation process is additionally indicated. The oxygen partial pressure oxidation p₀₂ of oxygen (O₂) is thus expressed in the unit bar and the temperature in the unit degree Celsius or the reciprocal value of the temperature expressed in the unit K⁻¹. The oxygen partial pressure oxidation relates to the oxygen partial pressure which, when reached or exceeded, causes an oxidation process of the respective material at the temperature T. When setting a specified temperature and the corresponding oxygen partial pressure oxidation of the corresponding material, oxidation of the material takes place. The diagram readily shows that the oxygen partial pressure oxidation for aluminum (Al) is smaller for a specified temperature than that of iron (Fe).

A first oxygen partial pressure p₁ corresponds to the oxygen partial pressure oxidation of a first material at a specified temperature. A second oxygen partial pressure corresponds to the oxygen partial pressure oxidation of a second material at the same temperature. The diagram illustrates this by way of example for a temperature T=900° C. The first material is aluminum, the second material iron or steel. It is readily apparent that the first oxygen partial pressure is lower than the second oxygen partial pressure. Correspondingly, at the pre-set temperature in an environment in which an oxygen partial pressure is present that is greater than the first oxygen partial pressure, but smaller than the second oxygen partial pressure, the first material, namely aluminum, oxidizes, while the second material, namely iron, does not oxidize. Accordingly, the heat treatment of the turbine rotor 1 should be carried out in an environment in which the oxygen partial pressure is set to be greater than the first oxygen partial pressure and smaller than the second oxygen partial pressure at the predefined temperature.

### LIST OF REFERENCE SIGNS

1 Turbine rotor

2 Turbine wheel

3 Shaft

4 Hub

5 Turbine blade

6 Rotation Axis

7 Hub end face

8 Wheel back

9 Polyhedron

10 Centering pin

11 Recess

12 Recess

13 Fastening protrusion

14 End face

15 End face

16 Solder film

17 Blade end face

18 Device

19 1. Chamber

20 2. Chamber

21 Housing

22 Insulation

23 Heating device

1.-6. (canceled)

7. A method for producing a turbine rotor of an exhaust gas turbocharger, comprising:
producing from a first material a turbine wheel having a hub and turbine blades extending from the hub;
producing a shaft from a second material that is different from the first material;
connecting the shaft to the hub of the turbine wheel;
applying halogen to a surface of the turbine wheel; and
heat treating the turbine wheel in an environment with an oxygen partial pressure which is greater than a first oxygen partial pressure at which the first material oxidizes, and smaller than a second oxygen partial pressure at which the second material oxidizes, thereby forming a protective coating on the surface.

8. The method of claim 7, wherein the first material is a titanium alloy.

9. The method of claim 7, wherein the first material is a titanium aluminide.

10. The method of claim 7, wherein the second material is steel.

11. The method of claim 7, wherein the turbine wheel is heat-treated at a temperature of at least 500° C. to at least 900° C.

12. The method of claim 7, further comprising hardening at least one area of the shaft before the shaft is connected to the hub.

13. The method of claim 7, further comprising hardening at least one region of the shaft by a further heat treating process after the turbine wheel is heat-treated.

14. The method of claim 7, further comprising hardening at least one bearing site of the shaft by a further heat treating process after the turbine wheel is heat-treated.
